(19) United States
(12) Patent Application Publication
(10) Pub. No.: US 2026/0255036 A1
(43) Pub. Date: Aug. 27, 2026

(54) OPTICAL ELEMENT DRIVING MECHANISM

(71) Applicant: TDK Corporation, Tokyo (JP)

(72) Inventors: Pai-Jui CHENG, Taoyuan City (TW); Shu-Shan CHEN, Taoyuan City (TW); Chuan-Min LEE, Taoyuan City (TW)

(73) Assignee: TDK Corporation, Tokyo (JP)

(21) Appl. No.: 19/542,241

(22) Filed: Feb. 17, 2026

(30) Foreign Application Priority Data
Feb. 27, 2025 (CN) 202520333561.7

(51) Int. Cl. H04N 23/54

(52) U.S. Cl. CPC H04N 23/54

(57) ABSTRACT

An optical element driving mechanism includes a first optical module and a second optical module, and the first optical module includes a fixed assembly, a first movable part and a first driving assembly. The first movable part is configured to be connected to the second optical module, and the first movable part is movable relative to the fixed assembly. The first driving assembly is configured to drive the first movable part to move relative to the fixed assembly.

### CROSS REFERENCE TO RELATED APPLICATIONS

This application claims the benefit of China Patent Application No. 202520333561.7, filed on February 27, 2025, the entirety of which is incorporated by reference herein.

### TECHNICAL FIELD

The present disclosure relates to an optical element driving mechanism, and in particular it relates to an optical element driving mechanism having a piezoelectric element.

### BACKGROUND

As technology has developed, many of today’s electronic devices (such as smartphones) have been equipped with a camera, or with video functionality. Using the camera modules disposed on electronic devices, users can operate them to capture photographs and record videos.

Today's designs of electronic devices continue to follow the trend of miniaturization, meaning that the various components of a camera module and its structure must also be continuously reduced in size, so as to achieve miniaturization. In general, a driving mechanism in a camera module has a camera lens holder configured to hold a camera lens, and the driving mechanism can have the functions of auto focusing or optical image stabilization. Although existing driving mechanisms can achieve the aforementioned functions of photographing and video recording, however, they still cannot meet all users’ needs.

Therefore, how to design a camera module that can be rapidly positioned and perform multiple functions are topics nowadays that need to be discussed and solved.

### BRIEF SUMMARY

Accordingly, one objective of the present disclosure is to provide an optical element driving mechanism to solve the problems mentioned above.

According to some embodiments of the disclosure, an optical element driving mechanism includes a first optical module and a second optical module, and the first optical module includes a fixed assembly, a first movable part and a first driving assembly. The first movable part is configured to be connected to the second optical module, and the first movable part is movable relative to the fixed assembly. The first driving assembly is configured to drive the first movable part to move relative to the fixed assembly.

According to some embodiments, the fixed assembly has a first base. The first movable part is configured to be movably connected to the first base along a main axis. The first optical module further includes a first positioning base which is connected to the first base. The first optical module further includes a first connecting assembly configured to connect the first driving assembly and the first positioning base to the first base. The first connecting assembly includes a first connecting element and a second connecting element. The first connecting element is configured to connect the first positioning base and the first driving assembly. The first base has an installation portion. The second connecting element is configured to connect the first positioning base and the installation portion.

According to some embodiments, the first base has a first accommodation space which is configured to accommodate at least a portion of the first driving assembly and the first positioning base. The first driving assembly has a first transmission assembly, a first contact element and a first power source. The first power source is configured to generate a first driving force which is configured to push the first transmission assembly. The first transmission assembly is configured to transmit the first driving force. The first contact element is disposed on the first transmission assembly and is configured to transmit the first driving force. The first accommodation space has a first avoiding space corresponding to the first transmission assembly. The first base has a first accommodating surface which is disposed in the first accommodation space and is configured to support a portion of the first positioning base.

According to some embodiments, the first base defines a first axis and a second axis. The first axis is perpendicular to the second axis. The first base further includes a first plane, a second plane and a step structure. The step structure is formed between the first plane and the second plane. When viewed along the first axis, the first plane overlaps the second connecting element. When viewed along the first axis, the second plane does not overlap the second connecting element. When viewed along the second axis, the step structure overlaps the installation portion.

According to some embodiments, the second optical module includes a second driving assembly, a second positioning base and a second base. The second positioning base is fixedly disposed on the second base. The second optical module further includes a second connecting assembly which is configured to connect the second driving assembly and the second positioning base to the second base. The second connecting assembly includes a third connecting element and a fourth connecting element. The third connecting element is configured to connect the second positioning base and the second driving assembly. The fourth connecting element is configured to connect the second positioning base and the second base. The second base further has a second accommodation space which is configured to accommodate at least a portion of the second positioning base.

According to some embodiments, the first optical module further includes a first rotary assembly which is disposed on the first base. The first rotary assembly has a first stator and a first rotor. The first stator is located between a positioning protruding portion of the first base and the first rotor. The first movable part is fixedly connected to the first rotor. The first contact element drives the first rotor to rotate relative to the first stator around a first rotation axis according to the first driving force.

According to some embodiments, the second driving assembly has a second transmission assembly, a second contact element and a second power source. The second power source is configured to generate a second driving force. The second power source is configured to push the second transmission assembly. The second transmission assembly is configured to transmit the second driving force. The second contact element is disposed on the second transmission assembly and is configured to transmit the second driving force. The second optical module further includes a second movable part. The second base is fixedly disposed on the first movable part, and the second movable part is movable relative to the second base.

According to some embodiments, the second optical module further has a second rotary assembly and a fixed shaft. The second movable part is movably connected to the second base through the second rotary assembly and the fixed shaft. The fixed shaft passes through the second base and the second rotary assembly. The second driving force is transmitted to the second rotary assembly through the second contact element to drive the second movable part to rotate around a second rotation axis. The second rotation axis is perpendicular to the first rotation axis.

According to some embodiments, the second connecting element has a first connecting end, a second connecting end, a first flexible portion, and a third connecting end. The first connecting end and the third connecting end are fixedly connected to the first base. The second connecting end is fixedly connected to the first positioning base. The first base has a first fixed protruding portion, a second fixed protruding portion, a third fixed protruding portion and a fourth fixed protruding portion. The first connecting end has a first installation hole and a second installation hole which are respectively mounted on the first fixed protruding portion and the second fixed protruding portion. The third connecting end has a third installation hole and a fourth installation hole which are respectively mounted on the third fixed protruding portion and the fourth fixed protruding portion.

According to some embodiments, the fourth connecting element has an elastic material. The fourth connecting element has a fourth connecting end, a fifth connecting end, a second flexible portion and a sixth connecting end. The fourth connecting end and the sixth connecting end are fixedly connected to the second base. The fifth connecting end is fixedly connected to the second positioning base. The second flexible portion is connected between the fourth connecting end and the fifth connecting end. The second base has a fifth fixed protruding portion, a sixth fixed protruding portion, a seventh fixed protruding portion and an eighth fixed protruding portion. The fourth connecting end has a fifth installation hole and a sixth installation hole which are respectively mounted on the fifth fixed protruding portion and the sixth fixed protruding portion.

According to some embodiments, when viewed along the first axis, the size of the fifth installation hole is equal to the size of the fifth fixed protruding portion. When viewed along the first axis, the size of the sixth installation hole is larger than the size of the sixth fixed protruding portion. When viewed along the first axis, the sixth installation hole extends along the second axis. The sixth connecting end has a seventh installation hole and an eighth installation hole which are respectively mounted on the seventh fixed protruding portion and the eighth fixed protruding portion. When viewed along the first axis, the size of the seventh installation hole is equal to the size of the seventh fixed protruding portion. When viewed along the first axis, the size of the eighth installation hole is larger than the size of the eighth fixed protruding portion.

According to some embodiments, the first optical module further includes a first circuit assembly, an integrated circuit assembly and an external-connection circuit assembly. The first circuit assembly and the integrated circuit assembly are fixedly disposed on the first base. The first circuit assembly is electrically connected to an external circuit through the integrated circuit assembly and the external-connection circuit assembly. The first circuit assembly has a first segment, a second segment, a third segment and a fourth segment. The first base has a top surface and a side wall. The first segment and the second segment are affixed to the top surface and the side wall respectively. The third segment is connected between the second segment and the fourth segment. The fourth segment is electrically connected to the integrated circuit assembly.

According to some embodiments, the second optical module further includes a second circuit assembly which is configured to be electrically connected to the second driving assembly and the integrated circuit assembly. The second circuit assembly has a fifth segment, a sixth segment, a seventh segment, and an eighth segment. The fifth segment is fixedly connected to the second base. The sixth segment is connected between the fifth segment and the seventh segment. The seventh segment extends along the main axis. The eighth segment is bent from the seventh segment and connected to the integrated circuit assembly. When viewed along the main axis, the sixth segment has a V-shaped structure. The second circuit assembly further has a fixed segment which is bent from the fifth segment. The fixed segment is fixedly disposed on the first movable part.

According to some embodiments, the second base has a first engaging protruding portion, a second engaging protruding portion, a third engaging protruding portion, a fourth engaging protruding portion, and a fifth engaging protruding portion. The fifth segment has a first engaging hole, a second engaging hole, a third engaging hole, and a fourth engaging hole. The first engaging protruding portion, the second engaging protruding portion, the third engaging protruding portion, and the fourth engaging protruding portion are configured to respectively engage with the first engaging hole, the second engaging hole, the third engaging hole, and the fourth engaging hole.

According to some embodiments, when viewed along the second axis, the size of the first engaging hole is equal to the size of the first engaging protruding portion. When viewed along the second axis, the size of the second engaging hole is larger than the size of the second engaging protruding portion. When viewed along the second axis, the size of the third engaging hole is larger than the size of the third engaging protruding portion. When viewed along the second axis, the size of the fourth engaging hole is larger than the size of the fourth engaging protruding portion. When viewed along the second axis, the fourth engaging hole has a long strip-shaped structure which extends along the first axis.

According to some embodiments, the second base has a through hole, and the fixed shaft is configured to pass through the through hole. When viewed along the main axis, the length of the through hole is greater than the length of the fixed shaft. The second optical module further includes a second sensing element and a second magnetic element. The through hole and the fixed shaft form an accommodation space which is configured to accommodate the second sensing element. The second sensing element is disposed on the fifth segment.

According to some embodiments, the second movable part has a side accommodating portion which is disposed on one side of the second base, corresponding to the accommodation space. The side accommodating portion has an accommodating groove which is configured to accommodate the second magnetic element. When viewed along the main axis, the second magnetic element and the second sensing element are located on opposite sides of the fifth segment. When viewed along the second axis, the side accommodating portion overlaps the second sensing element, the fixed shaft and the through hole.

According to some embodiments, the second circuit assembly further includes a first bent segment, a second bent segment and a third bent segment. The first bent segment is connected between the fifth segment and the sixth segment. The second bent segment is connected between the sixth segment and the seventh segment. The sixth segment has a first straight section and a second straight section. The third bent segment is connected between the first straight section and the second straight section.

According to some embodiments, the second optical module further includes a first reinforcing element, a second reinforcing element and a third reinforcing element. The first reinforcing element is fixedly connected to a portion of the fifth segment. The second reinforcing element is fixedly connected to a portion of the seventh segment. The third reinforcing element is fixedly connected to the third bent segment.

According to some embodiments, the fixed segment is formed with a fifth engaging hole, and the fifth engaging protruding portion is configured to pass through the fifth engaging hole. When viewed along the main axis, the size of the fifth engaging hole is greater than the size of the fifth engaging protruding portion. When viewed along the main axis, the fifth engaging hole has a long strip-shaped structure which extends along the second axis. The fixed segment is further formed with two second electrical contacts, which are configured to be electrically connected to the second power source. The second power source has two leading wires. The second positioning base has two notches. The two leading wires are configured to respectively pass through the two notches and then to be electrically connected to the two second electrical contacts.

The present disclosure provides an optical element driving mechanism 10, including a first optical module, a second optical module, a first driving assembly, and a second driving assembly. The second movable part of the second optical module is configured to carry an imaging module, and the second optical module is fixedly disposed on the first movable part of the first optical module. The first driving assembly is configured to drive the first movable part and the second optical module to rotate around the first rotation axis, and the second driving assembly is configured to drive the second movable part and the imaging module to rotate around the second rotation axis relative to the first movable part and the first base.

Furthermore, the optical element driving mechanism 10 may further include a first circuit assembly, a second circuit assembly, an integrated circuit assembly, and an external-connection circuit assembly, and the first circuit assembly and the second circuit assembly may be electrically connected to an external circuit through the integrated circuit assembly and the external-connection circuit assembly. The second circuit assembly has a fifth segment, a sixth segment, a seventh segment, and an eighth segment. The fifth segment is fixedly connected to the second base. The sixth segment is connected between the fifth segment and the seventh segment, and the eighth segment is bent from the seventh segment and connected to the integrated circuit assembly.

In addition, the fifth segment may be formed with a plurality of engaging holes, and the second base may be correspondingly formed with a plurality of engaging protruding portions to engage with the engaging holes respectively. Based on such a configuration, the fifth segment can be easily and accurately positioned on the second base, and the problem that the fifth segment may rotate around the second axis can also be avoided. Furthermore, the fifth segment can also be further fixed to the second base using glue to ensure that when the second base rotates, the fifth segment does not be separated from the second base.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a three-dimensional schematic diagram of an optical element driving mechanism 10 according to an embodiment of the present disclosure;

FIG. 2 is an exploded diagram of the optical element driving mechanism 10 according to an embodiment of the present disclosure;

FIG. 3 is a top view of a partial structure of the first optical module 100 according to an embodiment of the present disclosure;

FIG. 4 is a rear view of a partial structure of the first optical module 100 according to an embodiment of the present disclosure;

FIG. 5 is a three-dimensional diagram of a partial structure of the optical element driving mechanism 10 according to an embodiment of the present disclosure;

FIG. 6 is a three-dimensional diagram of a partial structure of the optical element driving mechanism 10 in another view according to an embodiment of the present disclosure;

FIG. 7 is a cross-sectional view of the optical element driving mechanism 10 along line A-A in FIG. 1 according to an embodiment of the present disclosure;

FIG. 8 is a top view illustrating that the first movable part 108 is driven and located at different positions according to an embodiment of the present disclosure;

FIG. 9 is an enlarged schematic diagram of the optical element driving mechanism 10 according to an embodiment of the present disclosure;

FIG. 10 is a top view of the optical element driving mechanism 10 according to an embodiment of the present application;

FIG. 11 is a side view of the optical element driving mechanism 10 according to an embodiment of the present disclosure; and

FIG. 12 is a three-dimensional schematic diagram of the optical element driving mechanism 10 according to another embodiment of the present application.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature’s relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

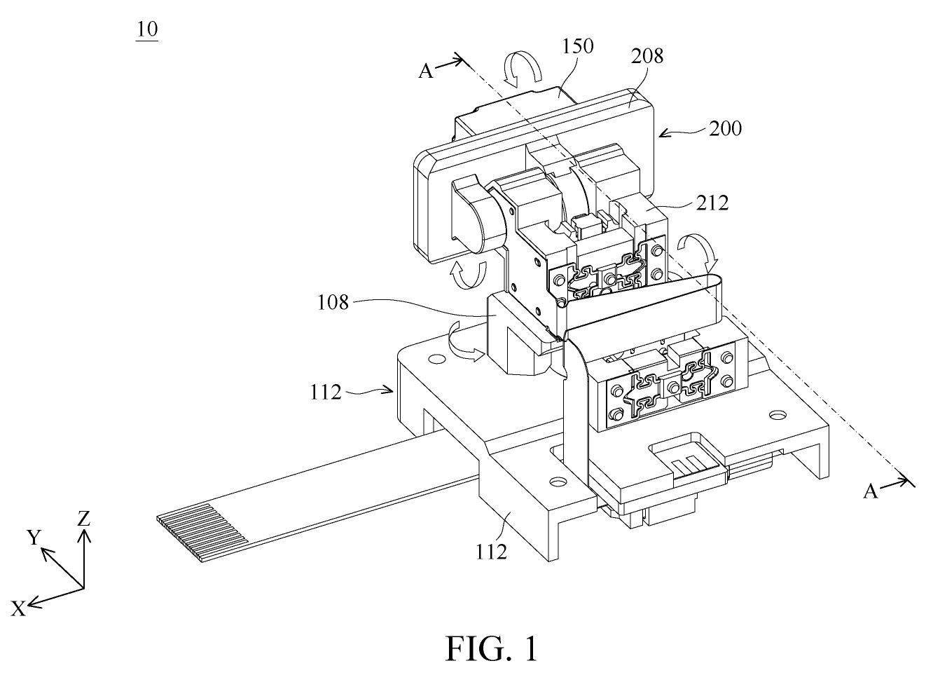

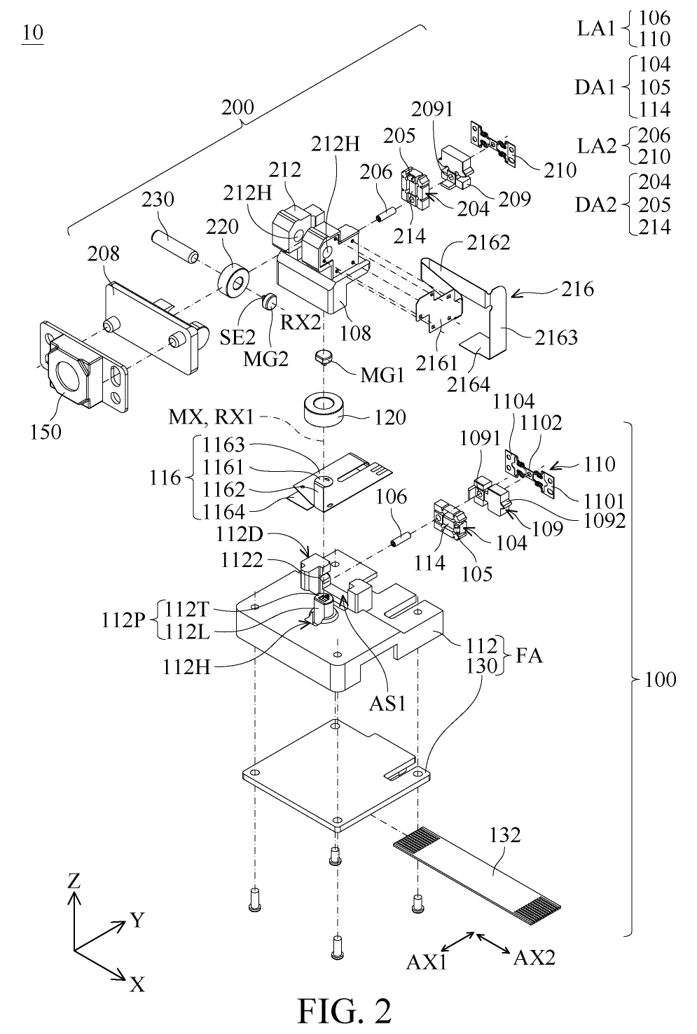

Please refer to FIG. 1 and FIG. 2. FIG. 1 is a three-dimensional schematic diagram of an optical element driving mechanism 10 according to an embodiment of the present disclosure, and FIG. 2 is an exploded diagram of the optical element driving mechanism 10 according to an embodiment of the present disclosure. The optical element driving mechanism 10 can be an optical camera system configured to carry and drive an imaging module 150. The optical element driving mechanism 10 can be installed in various electronic devices or portable electronic devices, such as a smart TV or a notebook computer, so that the user can perform image capture functions.

In this embodiment, the optical element driving mechanism 10 can have a first optical module 100 and a second optical module 200. The second optical module 200 is disposed on the first optical module 100, and the second optical module 200 is configured to carry the imaging module 150.

As shown in FIG. 1 and FIG. 2, in the first optical module 100, the first optical module 100 includes a fixed assembly FA, a first movable part 108, a first driving assembly DA1, and a first rotary assembly 120. The fixed assembly FA includes a first base 112, and the first movable part 108 is configured to be movably connected to the first base 112 along a main axis MX.

The first movable part 108 is configured to be connected to the second optical module 200, and the first movable part 108 is movable relative to the fixed assembly FA. Furthermore, the first driving assembly DA1 is configured to drive the first movable part 108 to move relative to the fixed assembly FA.

Specifically, the first movable part 108 is movably connected to the first base 112 by the first rotary assembly 120, and the first driving assembly DA1 drives the first movable part 108 to move through the first rotary assembly 120. Specifically, the first movable part 108 can rotate around a first rotation axis RX1. In this embodiment, the first rotation axis RX1 overlaps the main axis MX, but they are not limited thereto.

On the other hand, the second optical module 200 may include a second movable part 208, a second base 212, and a second driving assembly DA2. The second base 212 is fixedly disposed on the first movable part 108, and the second movable part 208 is movable relative to the second base 212. In this embodiment, the first movable part 108 and the second base 212 can be integrally formed as one piece.

Furthermore, the second optical module 200 may further include a second rotary assembly 220 and a fixed shaft 230, and the second movable part 208 is movably connected to the second base 212 through the second rotary assembly 220 and the fixed shaft 230.

The fixed shaft 230 passes through the second base 212 and the second rotary assembly 220, and the second driving assembly DA2 drives the second movable part 208 to move through the second rotary assembly 220. Specifically, the second movable part 208 may rotate around a second rotation axis RX2, and the second rotation axis RX2 may be defined by the fixed shaft 230. The second rotation axis RX2 may be, for example, perpendicular to the first rotation axis RX1, but they are not limited thereto.

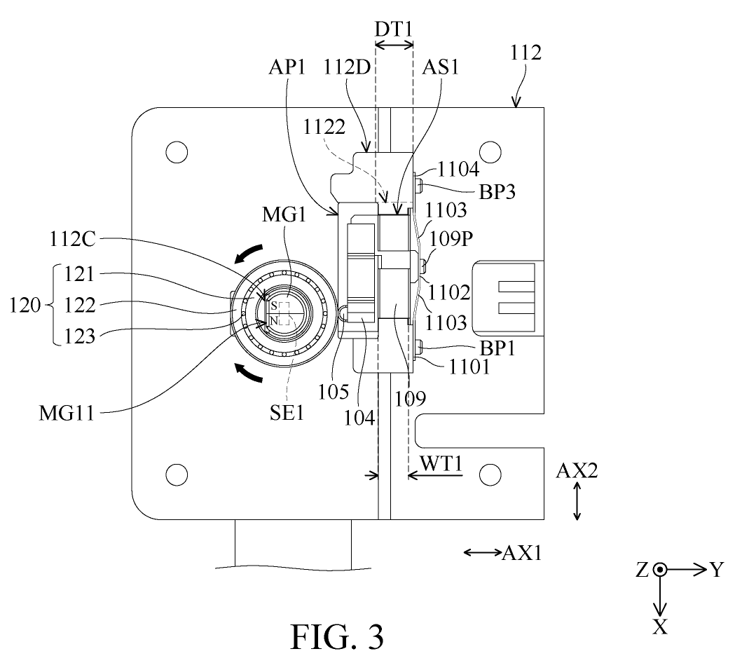

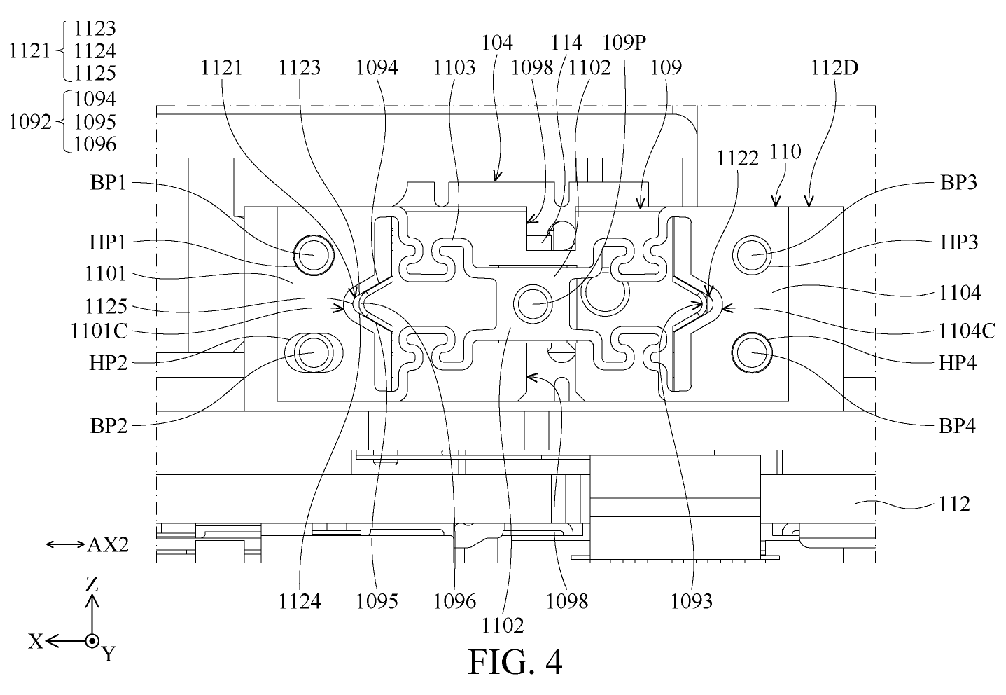

Next, please refer to FIG. 2 to FIG. 4. FIG. 3 is a top view of a partial structure of the first optical module 100 according to an embodiment of the present disclosure, and FIG. 4 is a rear view of a partial structure of the first optical module 100 according to an embodiment of the present disclosure. The first optical module 100 further includes a first positioning base 109, which is configured to be connected to the first base 112, and the first driving assembly DA1 is configured to be fixed on the first positioning base 109.

As shown in FIG. 2 and FIG. 3, the first base 112 can defines a first axis AX1 and a second axis AX2, and the second axis AX2 is perpendicular to the first axis AX1.

Furthermore, the first optical module 100 can further include a first connecting assembly LA1, which is configured to connect the first driving assembly DA1 and the first positioning base 109 to the first base 112. As shown in FIG. 2, the first connecting assembly LA1 includes a first connecting element 106, and the first connecting element 106 may be a screw, but it is not limited thereto.

As shown in FIG. 2, the first connecting element 106 can extend along the first axis AX1 and is configured to pass through the first positioning base 109 and the first driving assembly DA1 so as to connect the first positioning base 109 and the first driving assembly DA1. For example, the first connecting element 106 passes through the first driving assembly DA1 and is locked in a first mounting hole 1091 of the first positioning base 109.

Then, the first positioning base 109 and the first driving assembly DA1 are installed in an installation portion 112D of the first base 112 along the first axis AX1. Specifically, as shown in FIG. 2 to FIG. 4, the installation portion 112D of the first base 112 may have a first accommodation space AS1 configured to accommodate at least a portion of the first driving assembly DA1 and the first positioning base 109.

In this embodiment, as shown in FIG. 2 and FIG. 4, the first positioning base 109 has a first side protruding portion 1092 and a second side protruding portion 1093. Correspondingly, the first base 112 may be formed with a first guiding groove 1121 and a second guiding groove 1122 which are configured to guide the first side protruding portion 1092 and the second side protruding portion 1093, respectively.

When viewed along the first axis AX1 (the Y-axis), as shown in FIG. 4, the first side protruding portion 1092 has a first corresponding surface 1094, a second corresponding surface 1095 and a first terminal portion 1096. The first terminal portion 1096 is connected between the first corresponding surface 1094 and the second corresponding surface 1095.

As shown in FIG. 4, the first side protruding portion 1092 substantially has a triangular structure, and the angle between the first corresponding surface 1094 and the second corresponding surface 1095 is less than 60 degrees, but it is not limited thereto.

Furthermore, the first guiding groove 1121 has a third corresponding surface 1123, a fourth corresponding surface 1124 and a second terminal portion 1125. The second terminal portion 1125 is connected between the third corresponding surface 1123 and the fourth corresponding surface 1124. The third corresponding surface 1123 is configured to correspond to the first corresponding surface 1094, the fourth corresponding surface 1124 is configured to correspond to the second corresponding surface 1095, and the second terminal portion 1125 does not contact the first terminal portion 1096.

That is, there is a gap formed between the second terminal portion 1125 and the first terminal portion 1096. Similarly, there is a gap formed between the second side protruding portion 1093 and the second guiding groove 1122. In addition, there is a gap formed between the third corresponding surface 1123 and the first corresponding surface 1094, and there is a gap formed between the fourth corresponding surface 1124 and the second corresponding surface 1095. Based on such a structural configuration, it can be ensured that the first positioning base 109 is smoothly installed in the installation portion 112D.

In addition, in this embodiment, the second side protruding portion 1093 is symmetrical to the first side protruding portion 1092, and the second guiding groove 1122 is symmetrical to the first guiding groove 1121, so that the second side protruding portion 1093, and the second guiding groove 1122 have the same structures as the first side protruding portion 1092, and the first guiding groove 1121. Therefore, the detailed structure of the second side protruding portion 1093, and the second guiding groove 1122 are omitted herein.

Furthermore, in this embodiment, the first connecting assembly LA1 further includes a second connecting element 110 which is configured to connect the first positioning base 109 and the first base 112. As shown in FIG. 2 and FIG. 4, the second connecting element 110 has an elastic material. For example, the second connecting element 110 may be an elastic spring sheet, but it is not limited thereto.

As shown in FIG. 4, the second connecting element 110 has a first connecting end 1101, a second connecting end 1102, two first flexible portions 1103, and a third connecting end 1104. The first connecting end 1101 and the third connecting end 1104 are fixedly connected to the installation portion 112D of the first base 112, and the second connecting end 1102 is fixedly connected to the first positioning base 109.

One of the two first flexible portions 1103 is connected between the first connecting end 1101 and the second connecting end 1102, and the other one is connected between the third connecting end 1104 and the second connecting end 1102.

Specifically, the first base 112 has a first fixed protruding portion BP1, a second fixed protruding portion BP2, a third fixed protruding portion BP3 and a fourth fixed protruding portion BP4. The first connecting end 1101 has a first installation hole HP1 and a second installation hole HP2, which are respectively mounted on the first fixed protruding portion BP1 and the second fixed protruding portion BP2.

When viewed along the first axis AX1, the size of the first installation hole HP1 is slightly larger than the size of the first fixed protruding portion BP1, for example, 1.05 times. When viewed along the first axis AX1, the size of the second installation hole HP2 is larger than the size of the second fixed protruding portion BP2, for example, 1.5 times. When viewed along the first axis AX1, the second installation hole HP2 has a long strip-shaped structure which extends along the second axis AX2.

Similarly, the third connecting end 1104 has a third installation hole HP3 and a fourth installation hole HP4, which are respectively mounted on the third fixed protruding portion BP3 and the fourth fixed protruding portion BP4. When viewed along the first axis AX1, the size of the third installation hole HP3 is substantially equal to the size of the third fixed protruding portion BP3 (within the tolerance range). When viewed along the first axis AX1, the size of the fourth installation hole HP4 is slightly larger than the size of the fourth fixed protruding portion BP4, for example, 1.05 times.

In addition, as shown in FIG. 3 and FIG. 4, the first positioning base 109 may have a central fixed protruding portion 109P which passes through the second connecting end 1102. Since the second connecting element 110 is elastic, the first flexible portion 1103 and the second connecting end 1102 generate an elastic restoring force to the first positioning base 109 to push the first positioning base 109 and the first driving assembly DA1, so that the first driving assembly DA1 can actually contact the first rotary assembly 120, and then can correctly drive the first rotary assembly 120. In this embodiment, the elastic restoring force (the pre-pressure) may be less than or equal to 100 grams, but it is not limited thereto.

In addition, as shown in FIG. 4, the first connecting end 1101 has a first side notch 1101C, and the third connecting end 1104 has a second side notch 1104C. Their shapes and sizes correspond to the first guiding groove 1121 and the second guiding groove 1122, respectively. Based on such a configuration, the position of the first positioning base 109 can be easily adjusted, and the purpose of lightweight can be further achieved.

Furthermore, in this embodiment, as shown in FIG. 3, the second guiding groove 1122 (or the first guiding groove 1121) can have a first depth DT1 on the first axis AX1, and the first positioning base 109 can have a first width WT1 on the first axis AX1.

The first depth DT1 is greater than the first width WT1, which means that there is enough space to adjust the position of the first positioning base 109 on the installation portion 112D so that the first driving assembly DA1 can actually contact the first rotary assembly 120 so as to correctly drive the first rotary assembly 120.

In this embodiment, as shown in FIG. 2 and FIG. 3, the first driving assembly DA1 has a first transmission assembly 104, a first contact element 105, and a first power source 114. The first power source 114 is configured to generate a first driving force, and the first transmission assembly 104 is configured to transmit the first driving force.

In this embodiment, the first transmission assembly 104 has an elastic structure that can deform to output the first driving force. Specifically, the first power source 114 may be a first piezoelectric element which is configured to generate deformation to push the first transmission assembly 104, so that the first transmission assembly 104 deforms to output the first driving force.

The first contact element 105 has a semi-cylindrical structure, which is fixedly disposed on the first transmission assembly 104 and is configured to transmit the first driving force. The first rotary assembly 120 is disposed on the first base 112, and a portion of the first rotary assembly 120 is configured to move relative to the first contact element 105.

Specifically, when the first transmission assembly 104 deforms, the first contact element 105 can be driven to move along an elliptical trajectory (when viewed along the main axis MX, as shown in FIG. 3), thereby repeatedly contacting and driving a portion of the first rotary assembly 120 to move. The operation manner of the first transmission assembly 104 and the first contact element 105 can refer to Chinese Patent Application No. 202420942976.X, so it is omitted herein.

It is worth noting that, as shown in FIG. 2 to FIG. 3, the first accommodation space AS1 can have a first avoiding space AP1 corresponding to the first transmission assembly 104. The first avoiding space AP1 may be an opening, and a portion of the first transmission assembly 104 is located in the first avoiding space AP1. Based on the configuration of the first avoiding space AP1, the problem of damage caused by collision between the first transmission assembly 104 and the first base 112 when the first transmission assembly 104 deforms can be avoided.

Furthermore, as shown in FIG. 2 to FIG. 3, the first rotary assembly 120 is sleeved over a positioning protruding portion 112P of the first base 112, and the first rotary assembly 120 has a first stator 121, a first rotor 122, and a plurality of first rolling balls 123. The first stator 121 is located between the positioning protruding portion 112P and the first rotor 122, and the first rolling balls 123 are located between the first stator 121 and the first rotor 122, so that the first rotor 122 can rotate relative to the first stator 121.

The first movable part 108 is fixedly connected to the first rotor 122, and the first contact element 105 drives the first rotor 122 to rotate relative to the first stator 121 around the first rotation axis RX1 according to the aforementioned first driving force, so that the first movable part 108 drives the second optical module 200 to rotate around the first rotation axis RX1. The first rotation axis RX1 can be defined by the positioning protruding portion 112P.

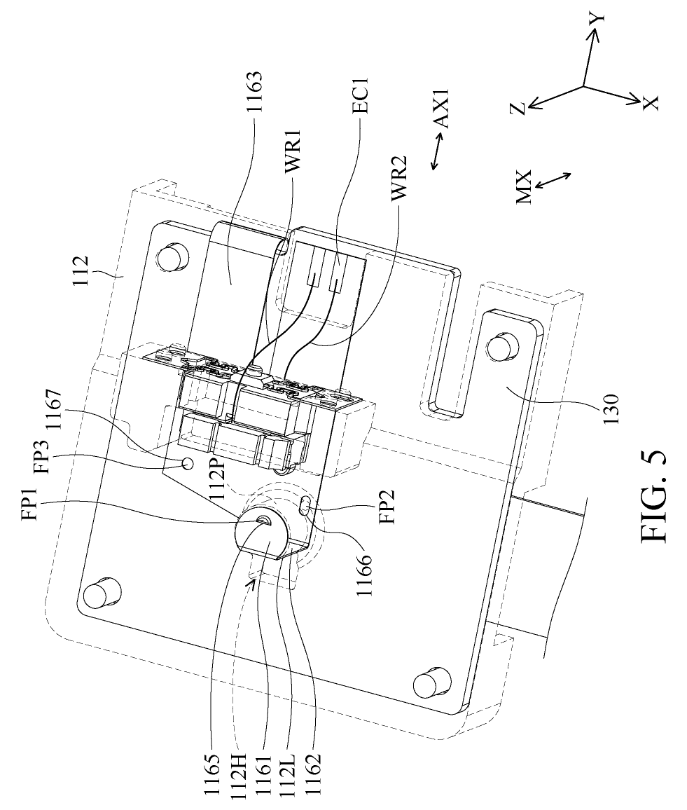

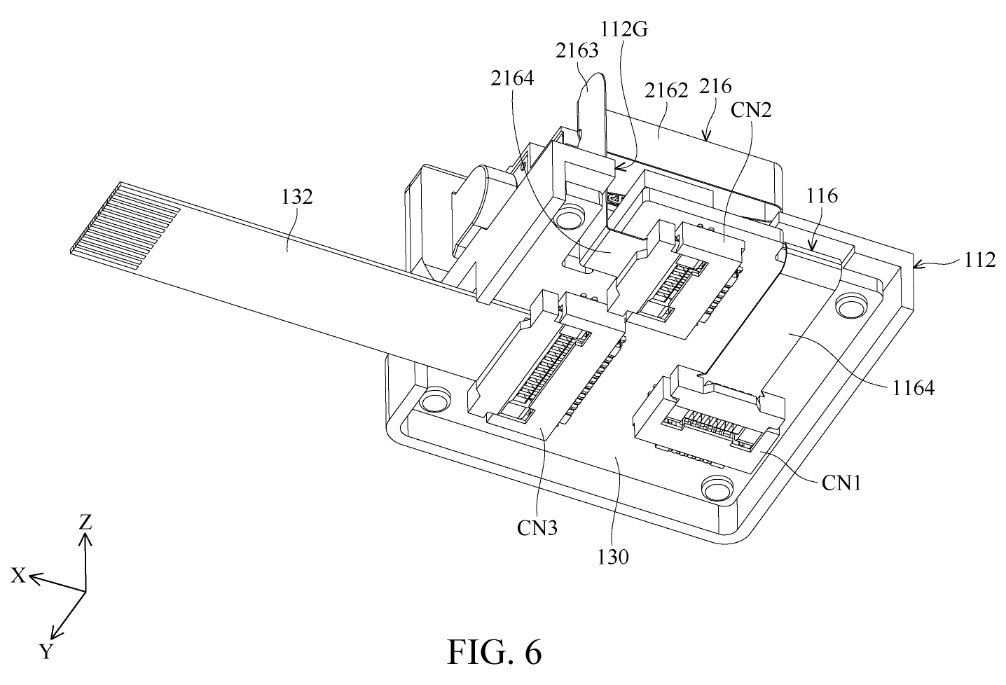

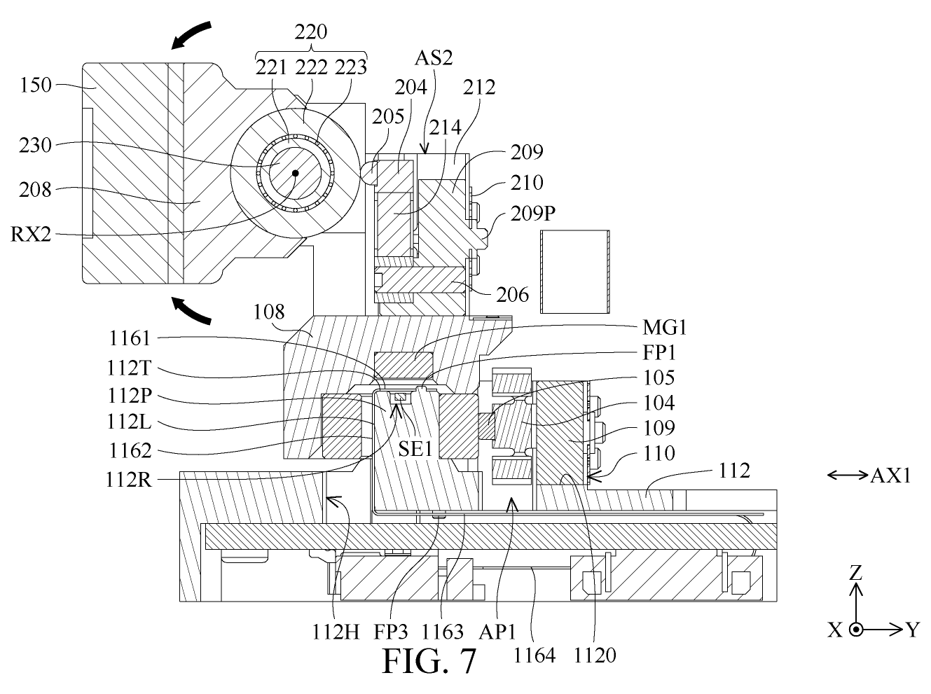

Next, refer to FIG. 2 and FIG. 5 to FIG. 7. FIG. 5 is a three-dimensional diagram of a partial structure of the optical element driving mechanism 10 according to an embodiment of the present disclosure, FIG. 6 is a three-dimensional diagram of a partial structure of the optical element driving mechanism 10 in another view according to an embodiment of the present disclosure, and FIG. 7 is a cross-sectional view of the optical element driving mechanism 10 along line A-A in FIG. 1 according to an embodiment of the present disclosure.

As shown in FIG. 2, FIG. 5 and FIG. 6, the first optical module 100 may further include a first circuit assembly 116, an integrated circuit assembly 130 and an external-connection circuit assembly 132. The first circuit assembly 116 and the integrated circuit assembly 130 are fixedly disposed on the first base 112, and the first circuit assembly 116 may be electrically connected to an external circuit through the integrated circuit assembly 130 and the external-connection circuit assembly 132.

As shown in FIG. 2 and FIG. 5, the first circuit assembly 116 has a first segment 1161, a second segment 1162, a third segment 1163, and a fourth segment 1164. The positioning protruding portion 112P has a top surface 112T and a side wall 112L. The first segment 1161 and the second segment 1162 are affixed to the top surface 112T and the side wall 112L, respectively.

The third segment 1163 is connected between the second segment 1162 and the fourth segment 1164, and the fourth segment 1164 is bent from the third segment 1163 and is electrically connected to the integrated circuit assembly 130. Specifically, as shown in FIG. 6, a first connector CN1 is disposed on the integrated circuit assembly 130 and is configured to connect the fourth segment 1164.

The first base 112 further has a communicating opening 112H, and the second segment 1162 is bent from the third segment 1163 and passes through the communicating opening 112H to be connected to the first segment 1161. The communicating opening 112H passes through the first base 112 along the main axis MX.

As shown in FIG. 5, the first segment 1161 has a first positioning hole 1165, and the positioning protruding portion 112P further has a first installation protruding portion FP1 which passes through the first positioning hole 1165. When viewed along the main axis MX (the Z-axis), the first installation protruding portion FP1 and the first positioning hole 1165 each have a semicircular structure.

Based on the structural design of the semicircular structure, the first segment 1161 can be correctly positioned. In addition, glue (not shown in the figures) may be provided between the first segment 1161 and the top surface 112T, and glue may also be provided between the second segment 1162 and the side wall 112L, so as to securely fix the first segment 1161 and the second segment 1162 to the top surface 112T and the side wall 112L, respectively.

Furthermore, as shown in FIG. 5 and FIG. 7, the third segment 1163 has a second positioning hole 1166 and a third positioning hole 1167. Correspondingly, the first base 112 further has a second installation protruding portion FP2 and a third installation protruding portion FP3, which extend along the main axis MX and pass through the second positioning hole 1166 and the third positioning hole 1167, respectively.

When viewed along the main axis MX, as shown in FIG. 5, the size of the second positioning hole 1166 is larger than the size of the second installation protruding portion FP2, for example, 1.5 times. When viewed along the main axis MX, the second positioning hole 1166 has a long strip-shaped structure which extends along the first axis AX1.

When viewed along the main axis MX, the size of the third positioning hole 1167 is slightly larger than the size of the third installation protruding portion FP3, for example, 1.05 times. When viewed along the main axis MX, the third positioning hole 1167 has a circular structure.

Based on the above-mentioned designs of the first positioning hole 1165, the second positioning hole 1166 and the third positioning hole 1167, the first circuit assembly 116 can be more easily installed on the first base 112.

It is also worth noting that two first electrical contacts EC1 may be formed on the third segment 1163 and are configured to be electrically connected to the first power source 114. When viewed along the main axis MX, the first electrical contacts EC1 are exposed from the first base 112 to facilitate welding with the leading wires WR1 and WR2 of the first power source 114.

As shown in FIG. 4, the first positioning base 109 may be formed with two notches 1098, and the two leading wires WR1 and WR2 of the first power source 114 (as shown in FIG. 5) may be pulled out to the first electrical contacts EC1 through the two notches 1098.

In addition, as shown in FIG. 2, FIG. 3 and FIG. 7, the first optical module 100 further includes a first magnetic element MG1, and the first magnetic element MG1 is fixedly disposed on the bottom of the first movable part 108.

As shown in FIG. 3, when viewed along the main axis MX, the positioning protruding portion 112P forms a first notch 112C. When viewed along the main axis MX, the first magnetic element MG1 forms a second notch MG11 corresponding to the first notch 112C.

The first notch 112C is communicated with the aforementioned communicating opening 112H. Based on the configuration of the first notch 112C, the second segment 1162 can be easily extended from the communicating opening 112H and easily installed on the side wall 112L.

In addition, based on the configuration of the second notch MG11, it can be ensured that when the first magnetic element MG1 is installed on the first movable part 108, the arrangement direction of the magnetic poles of the first magnetic element MG1 is correct, and there is no problem of installation error.

Next, as shown in FIG. 3 and FIG. 7, the first optical module 100 further includes a first sensing element SE1 which is disposed on the first segment 1161. Specifically, the first sensing element SE1 is accommodated in an accommodating recess 112R of the positioning protruding portion 112P and is located on the bottom of the first segment 1161.

As shown in FIG. 7, when viewed along the second axis AX2 (the X-axis), the first sensing element SE1 and the first magnetic element MG1 are located on opposite sides of the first segment 1161. Based on the above configuration, the first optical module 100 can achieve the purpose of miniaturization.

The first sensing element SE1 is configured to sense the magnetic field change of the first magnetic element MG1 to obtain the position of the first movable part 108 relative to the first base 112. In this embodiment, the first sensing element SE1 may be a Hall sensor or a tunneling magneto-resistance sensor (the TMR sensor), but it is not limited thereto. It is worth noting that, as shown in FIG. 3, the first sensing element SE1 has a rectangular structure, the long side of which is parallel to the second axis AX2, and the arrangement direction of the magnetic poles of the first magnetic element MG1 is also parallel to the second axis AX2.

Furthermore, as shown in FIG. 7, the first base 112 may further have a first accommodating surface 1120, which is disposed in the first accommodation space AS1. The first accommodating surface 1120 is configured to support a portion of the first positioning base 109. The first avoiding space AP1 is adjacent to the first accommodating surface 1120. In this embodiment, when viewed along the main axis MX, the area of the first accommodating surface 1120 may be less than or equal to the area of the first positioning base 109.

It should be noted that the first circuit assembly 116 may be a flexible circuit board and it may have six circuit lines embedded therein. The first power source 114 may be electrically connected to two of the circuit lines through the two first electrical contacts EC1, and the other four circuit lines may be used by the first sensing element SE1. Similarly, the external-connection circuit assembly 132 may also be a flexible circuit board and may have 12 circuit lines embedded therein, six of which are electrically connected to the six circuit lines of the first circuit assembly 116.

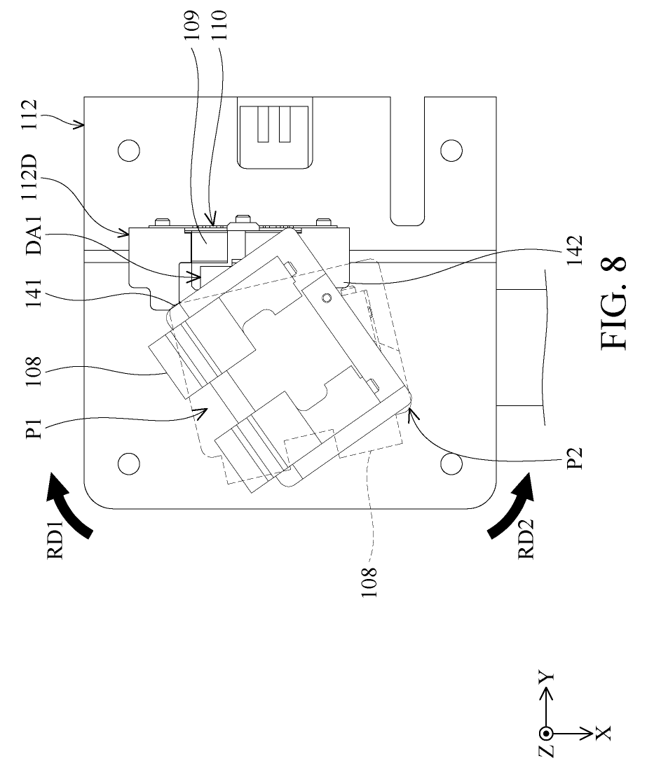

Next, please continue to refer to FIG. 8. FIG. 8 is a top view illustrating that the first movable part 108 is driven and located at different positions according to an embodiment of the present disclosure. In this embodiment, the installation portion 112D of the first base 112 further has a first stopper portion 141 and a second stopper portion 142.

The first stopper portion 141 and the second stopper portion 142 are, for example, chamfered structures, and the first stopper portion 141 and the second stopper portion 142 can be made of plastic material, but they are not limited thereto.

As shown in FIG. 8, when the first movable part 108 is driven by the first driving assembly DA1 to rotate in a first rotation direction RD1 (clockwise rotation), the first movable part 108 is configured to contact the first stopper portion 141. When the first movable part 108 contacts the first stopper portion 141, the position of the first movable part 108 can be referred to as a first extreme position P1.

On the contrary, when the first movable part 108 is driven by the first driving assembly DA1 to rotate in a second rotation direction RD2, the first movable part 108 is configured to contact the second stopper portion 142. When the first movable part 108 contacts the second stopper portion 142, the position of the first movable part 108 can be referred to as a second extreme position P2. The second rotation direction RD2 is opposite to the first rotation direction RD1.

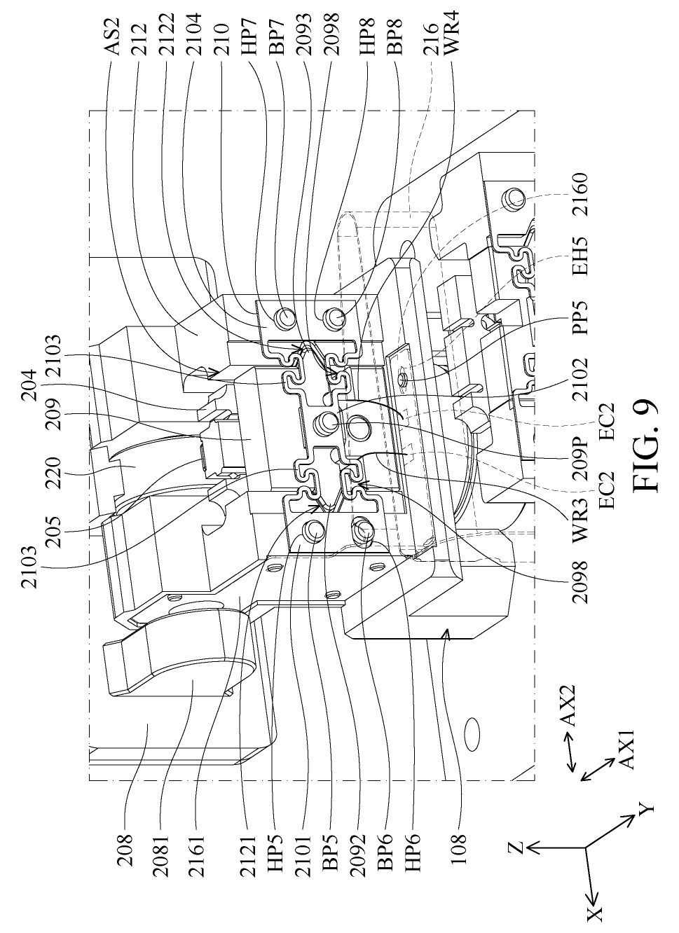

Next, please refer to FIG. 2, FIG. 7 to FIG. 9. FIG. 9 is an enlarged schematic diagram of the optical element driving mechanism 10 according to an embodiment of the present disclosure. Similar to the first optical module 100, the second optical module 200 may further include the aforementioned second driving assembly DA2 and a second positioning base 209.

The second positioning base 209 is fixedly disposed on the second base 212, and the second optical module 200 further includes a second connecting assembly LA2 which is configured to connect the second driving assembly DA2 and the second positioning base 209 to the second base 212 and the first movable part 108.

Specifically, as shown in FIG. 2, the second connecting assembly LA2 includes a third connecting element 206 which is configured to connect the second positioning base 209 and the second driving assembly DA2. For example, the third connecting element 206 may be a screw which passes through the second driving assembly DA2 and is locked in a second mounting hole 2091 of the second positioning base 209.

It is worth noting that the extending direction of the third connecting element 206 is parallel to the extending direction of the first connecting element 106. Therefore, such a configuration can increase the convenience of installing the first optical module 100 and the second optical module 200.

Then, the second positioning base 209 and the second driving assembly DA2 are installed on the second base 212 along the first axis AX1. As shown in FIG. 7 and FIG. 9, the second base 212 can further have a second accommodation space AS2 which is configured to accommodate at least a portion of the second positioning base 209 and the second driving assembly DA2. The second accommodation space AS2 may be a groove, but it is not limited thereto.

Similar to the first optical module 100, in this embodiment, as shown in FIG. 9, the second positioning base 209 has a third side protruding portion 2092 and a fourth side protruding portion 2093. Correspondingly, the second base 212 can be formed with a third guiding groove 2121 and a fourth guiding groove 2122 which are configured to guide the third side protruding portion 2092 and the fourth side protruding portion 2093 respectively.

In addition, the fourth side protruding portion 2093 is symmetrical to the third side protruding portion 2092, and the fourth guiding groove 2122 is symmetrical to the third guiding groove 2121. Since the structural configurations of the third side protruding portion 2092 and the fourth side protruding portion 2093 are the same or similar to the first side protruding portion 1092 and the second side protruding portion 1093, and the structural configurations of the third guiding groove 2121 and the fourth guiding groove 2122 are the same or similar to the first guiding groove 1121 and the second guiding groove 1122, their specific structures are not repeated herein.

Next, the second connecting assembly LA2 may further include a fourth connecting element 210 which is configured to connect the second positioning base 209 and the second base 212. The fourth connecting element 210 has an elastic material. For example, the fourth connecting element 210 is an elastic spring sheet, but it is not limited thereto.

The fourth connecting element 210 has a fourth connecting end 2101, a fifth connecting end 2102, two second flexible portions 2103, and a sixth connecting end 2104. The fourth connecting end 2101 and the sixth connecting end 2104 are fixedly connected to the second base 212, and the fifth connecting end 2102 is fixedly connected to the second positioning base 209.

One of the two second flexible portions 2103 is connected between the fourth connecting end 2101 and the fifth connecting end 2102, and the other one is connected between the sixth connecting end 2104 and the fifth connecting end 2102.

Specifically, the second base 212 has a fifth fixed protruding portion BP5, a sixth fixed protruding portion BP6, a seventh fixed protruding portion BP7, and an eighth fixed protruding portion BP8. The fourth connecting end 2101 has a fifth installation hole HP5 and a sixth installation hole HP6 which are respectively mounted on the fifth fixed protruding portion BP5 and the sixth fixed protruding portion BP6.

When viewed along the first axis AX1, the size of the fifth installation hole HP5 is slightly larger than the size of the fifth fixed protruding portion BP5, for example, 1.05 times. When viewed along the first axis AX1, the size of the sixth installation hole HP6 is larger than the size of the sixth fixed protruding portion BP6, for example, 1.5 times. When viewed along the first axis AX1, the sixth installation hole HP6 has a long strip-shaped structure which extends along the second axis AX2.

Similarly, the sixth connecting end 2104 has a seventh installation hole HP7 and an eighth installation hole HP8 which are respectively mounted on the seventh fixed protruding portion BP7 and the eighth fixed protruding portion BP8. When viewed along the first axis AX1, the size of the seventh installation hole HP7 is substantially equal to the size of the seventh fixed protruding portion BP7 (within the tolerance range). When viewed along the first axis AX1, the size of the eighth installation hole HP8 is slightly larger than the size of the eighth fixed protruding portion BP8, for example, 1.05 times.

Similarly, as shown in FIG. 9, the second positioning base 209 may have a central fixed protruding portion 209P which passes through the fifth connecting end 2102. Since the fourth connecting element 210 is elastic, the second flexible portion 2103 and the fifth connecting end 2102 generate an elastic restoring force to the second positioning base 209 to push the second positioning base 209 and the second driving assembly DA2, so that the second driving assembly DA2 can actually contact the second rotary assembly 220, so as to correctly drive the second rotary assembly 220.

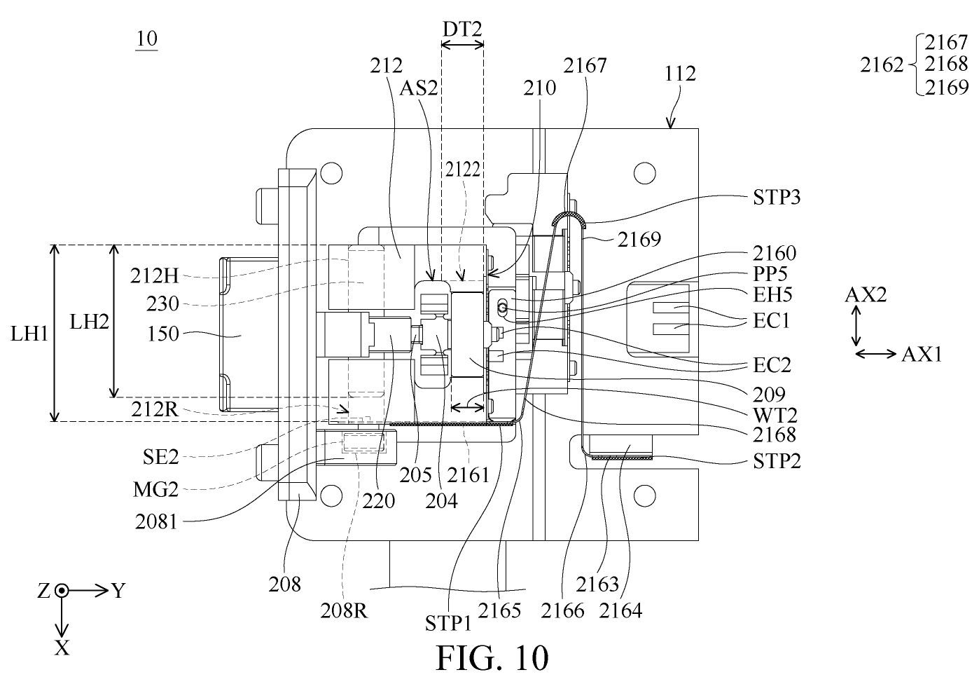

Furthermore, please refer to FIG. 2, FIG. 6, FIG. 9 and FIG. 10. FIG. 10 is a top view of the optical element driving mechanism 10 according to an embodiment of the present application. As shown in the figures, the second optical module 200 may further include a second circuit assembly 216 which is configured to be electrically connected to the second driving assembly DA2 and the integrated circuit assembly 130.

In this embodiment, as shown in FIG. 2, the second circuit assembly 216 has a fifth segment 2161, a sixth segment 2162, a seventh segment 2163, and an eighth segment 2164. The fifth segment 2161 is fixedly connected to the second base 212. The sixth segment 2162 is connected between the fifth segment 2161 and the seventh segment 2163, and the seventh segment 2163 extends along the main axis MX.

The eighth segment 2164 is bent from the seventh segment 2163 and is connected to the integrated circuit assembly 130. Specifically, as shown in FIG. 6, a second connector CN2 is disposed on the integrated circuit assembly 130 and is configured to connect the eighth segment 2164.

In addition, as shown in FIG. 6 , the seventh segment 2163 is configured to pass through an open slot 112G of the first base 112 and then to be connected to the sixth segment 2162. It is worth noting that the sixth segment 2162 is bent from the fifth segment 2161 and is connected to the seventh segment 2163. As shown in FIG. 10, when viewed along the main axis MX, the sixth segment 2162 may have a V-shaped structure.

The second circuit assembly 216 may be a flexible circuit board, and based on the above configuration, when the first movable part 108 drives the second optical module 200 to rotate around the first rotation axis RX1, the sixth segment 2162 may extend or contract along with the first movable part 108 without affecting the movement of the first movable part 108, and the problem of damage to the second circuit assembly 216 may also be avoided.

In this embodiment, as shown in FIG. 9 and FIG. 10, the second circuit assembly 216 further includes a fixed segment 2160 which is bent from the fifth segment 2161, and the fixed segment 2160 is fixedly disposed on the first movable part 108. The second driving assembly DA2 is configured to be electrically connected to the fixed segment 2160, and the specific connection method thereof will be described in the following paragraphs.

In addition, as shown in FIG. 6, a third connector CN3 is disposed on the integrated circuit assembly 130 and is configured to connect to the external-connection circuit assembly 132. That is, the signals of the first circuit assembly 116 and the second circuit assembly 216 can be integrated in the integrated circuit assembly 130 and then output to the external circuit via the external-connection circuit assembly 132.

Furthermore, similar to the first optical module 100, as shown in FIG. 9 and FIG. 10, the fourth guiding groove 2122 (or the third guiding groove 2121) may have a second depth DT2 on the first axis AX1, and the second positioning base 209 may have a second width WT2 on the first axis AX1.

The second depth DT2 is greater than the second width WT2. That is, there is enough space to adjust the position of the second positioning base 209 on the second base 212, so that the second driving assembly DA2 can actually contact the second rotary assembly 220 so as to correctly drive the second rotary assembly 220.

Please go back to FIG. 2 and FIG. 7. In this embodiment, the second rotary assembly 220 may have a second stator 221, a second rotor 222, and a plurality of second rolling balls 223. The second stator 221 is located between the fixed shaft 230 and the second rotor 222, and the second rolling balls 223 are located between the second stator 221 and the second rotor 222, so that the second rotor 222 can rotate relative to the second stator 221.

Similar to the first driving assembly DA1, the second driving assembly DA2 may have a second transmission assembly 204, a second contact element 205, and a second power source 214. The second power source 214 is configured to generate a second driving force, the second transmission assembly 204 is configured to transmit the second driving force, and the second transmission assembly 204 may have an elastic structure that can deform to output the second driving force.

Specifically, the second power source 214 can be a second piezoelectric element which is configured to generate deformation to push the second transmission assembly 204, so that the second transmission assembly 204 deforms to output the second driving force.

Similarly, the second contact element 205 is fixedly disposed on the second transmission assembly 204 and is configured to transmit the second driving force. When the second transmission assembly 204 deforms, the second contact element 205 can be driven to move along an elliptical trajectory (when viewed along the second axis AX2, as shown in FIG. 7), thereby repeatedly contacting and driving the second rotor 222 to rotate. The specific operation manner is the same as that of the first driving assembly DA1.

Furthermore, as shown in FIG. 7, the second movable part 208 is fixedly connected to the second rotor 222, and the second driving force is transmitted to the second rotor 222 through the second contact element 205 to drive the second rotor 222 and the second movable part 208 to rotate around the second rotation axis RX2 relative to the second stator 221, so that the second movable part 208 drives the imaging module 150 to rotate around the second rotation axis RX2.

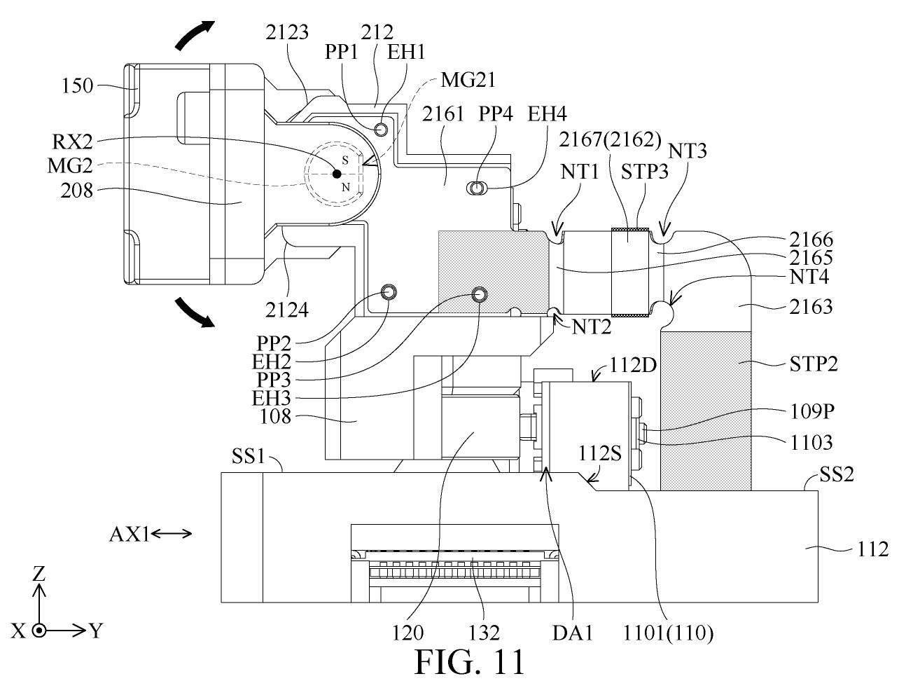

Next, please refer to FIG. 11. FIG. 11 is a side view of the optical element driving mechanism 10 according to an embodiment of the present disclosure. In this embodiment, as shown in FIG. 11, the second base 212 may have a third stopper portion 2123 and a fourth stopper portion 2124, and when the second movable part 208 is driven to rotate around the second rotation axis RX2, the third stopper portion 2123 and the fourth stopper portion 2124 may be configured to stop the second movable part 208 to limit the angle range of rotation of the second movable part 208.

The third stopper portion 2123 may be an inclined surface, and the fourth stopper portion 2124 may be a circular arc chamfer, but they are not limited thereto. Based on such a configuration, the rotation angle of the second movable part 208 is different. For example, in FIG. 11, the maximum angle of clockwise rotation of the second movable part 208 (the horizontal line is defined as 0 degrees) can be greater than the maximum angle of counterclockwise rotation. Such a configuration can ensure that the second movable part 208 does not collide with the first movable part 108.

In addition, as shown in FIG. 11, in this embodiment, the second base 212 may have a first engaging protruding portion PP1, a second engaging protruding portion PP2, a third engaging protruding portion PP3, and a fourth engaging protruding portion PP4, and the fifth segment 2161 has a first engaging hole EH1, a second engaging hole EH2, a third engaging hole EH3, and a fourth engaging hole EH4.

The first engaging protruding portion PP1, the second engaging protruding portion PP2, the third engaging protruding portion PP3, and the fourth engaging hole EH4 are configured to be respectively engaged with the first engaging hole EH1, the second engaging hole EH2, the third engaging hole EH3, and the fourth engaging hole EH4. When viewed along the second axis AX2, the size of the first engaging hole EH1 is substantially equal to the size of the first engaging protruding portion PP1 (within the tolerance range).

When viewed along the second axis AX2, the size of the second engaging hole EH2 is slightly larger than the size of the second engaging protruding portion PP2. When viewed along the second axis AX2, the size of the third engaging hole EH3 is slightly larger than the size of the third engaging protruding portion PP3, for example, 1.05 times.

Furthermore, when viewed along the second axis AX2, the size of the fourth engaging hole EH4 is larger than the size of the fourth engaging protruding portion PP4. Specifically, when viewed along the second axis AX2, the fourth engaging hole EH4 has a long strip-shaped structure which extends along the first axis AX1.

Based on such a structural design, the fifth segment 2161 can be easily and reliably positioned on the second base 212, and the problem that the fifth segment 2161 may rotate around the second axis AX2 when the second base 212 rotates around the first rotation axis RX1 can also be avoided.

Similarly, as shown in FIG. 9 and FIG. 10, the second base 212 may further include a fifth engaging protruding portion PP5, and the fixed segment 2160 may correspondingly form a fifth engaging hole EH5. The fifth engaging protruding portion PP5 is configured to pass through the fifth engaging hole EH5.

When viewed along the main axis MX, the size of the fifth engaging hole EH5 is greater than the size of the fifth engaging protruding portion PP5. Specifically, when viewed along the main axis MX, the fifth engaging hole EH5 has a long strip-shaped structure which extends along the second axis AX2.

Similar to the first circuit assembly 116, as shown in FIG. 9 and FIG. 10, the fixed segment 2160 may be formed with two second electrical contacts EC2, which are configured to be electrically connected to the second power source 214, and the second power source 214 may have a leading wire WR3 and a leading wire WR4.

As shown in FIG. 9, the second positioning base 209 may have two notches 2098, and the leading wire WR3 and the leading wire WR4 are configured to pass through the two notches 2098 and then to be electrically connected to the two second electrical contacts EC2 (for example, by welding).

Based on the above structural configuration, not only the second circuit assembly 216 does not affect the movement of the first movable part 108 and the second base 212, but also the second optical module 200 can achieve the purpose of miniaturization.

Please continue to refer to FIG. 10 and FIG. 11. In this embodiment, the second circuit assembly 216 further includes a first bent segment 2165, a second bent segment 2166, and a third bent segment 2167. The first bent segment 2165 is connected between the fifth segment 2161 and the sixth segment 2162, and the second bent segment 2166 is connected between the sixth segment 2162 and the seventh segment 2163.

As shown in FIG. 10, the sixth segment 2162 may have a first straight section 2168 and a second straight section 2169, and the third bent segment 2167 is connected between the first straight section 2168 and the second straight section 2169.

As shown in FIG. 10 and FIG. 11, the second optical module 200 may further include a first reinforcing element STP1, a second reinforcing element STP2, and a third reinforcing element STP3. The first reinforcing element STP1, the second reinforcing element STP2 and the third reinforcing element STP3 are, for example, thin plastic sheets, but they are not limited thereto. For example, in other embodiments, these reinforcing elements may also be made of metal materials.

In this embodiment, the first reinforcing element STP1 is fixedly connected to a portion of the fifth segment 2161, the second reinforcing element STP2 is fixedly connected to a portion of the seventh segment 2163, and the third reinforcing element STP3 is fixedly connected to the third bent segment 2167.

Based on the configuration of these reinforcing elements, the structural strength of the fifth segment 2161 and the seventh segment 2163 can be increased, so that when the second base 212 rotates, the first straight section 2168 and the second straight section 2169 can smoothly move away from each other or move close to each other, thereby ensuring the smoothness of the movement of the second base 212.

Furthermore, the second circuit assembly 216 may further include a first notch NT1, a second notch NT2, a third notch NT3, and a fourth notch NT4. The first notch NT1 and the second notch NT2 are formed in the first bent segment 2165, and the third notch NT3 and the fourth notch NT4 are formed in the second bent segment 2166.

Based on the configuration of the first notch NT1, the second notch NT2, the third notch NT3, and the fourth notch NT4, the flexibility of the second circuit assembly 216 may be increased so as to ensure smoothness of movement of the second base 212 and the first movable part 108.

In addition, as shown in FIG. 2, FIG. 10 and FIG. 11, the second optical module 200 further includes a second sensing element SE2 and a second magnetic element MG2, the second magnetic element MG2 is disposed on the second movable part 208, and the second sensing element SE2 is disposed on the fifth segment 2161.

Specifically, as shown in FIG. 2 and FIG. 10, the second base 212 has a through hole 212H, and the fixed shaft 230 is configured to pass through the through hole 212H. When viewed along the main axis MX, a first length LH1 of the through hole 212H is greater than a second length LH2 of the fixed shaft 230.

That is, the fixed shaft 230 does not fill all of the through hole 212H. Therefore, the through hole 212H and the fixed shaft 230 can form an accommodation space 212R which is configured to accommodate the second sensing element SE2.

Correspondingly, the second movable part 208 can have a side accommodating portion 2081 which is disposed on one side of the second base 212 and corresponds to the accommodation space 212R. The side accommodating portion 2081 has an accommodating groove 208R which is configured to accommodate the second magnetic element MG2.

It is worth noting that, as shown in FIG. 10, when viewed along the main axis MX, the second sensing element SE2 and the second magnetic element MG2 are disposed on opposite sides of the fifth segment 2161. When viewed along the second axis AX2, the side accommodating portion 2081 overlaps the second sensing element SE2, the fixed shaft 230, and the through hole 212H. Based on the above structural configuration, the second optical module 200 can further achieve the purpose of miniaturization.

In addition, as shown in FIG. 11, when viewed along the second axis AX2, the second magnetic element MG2 has a third notch MG21. The configuration and advantages of the third notch MG21 are similar to that of the second notch MG11, so it is omitted herein.

Similar to the first circuit assembly 116, the second circuit assembly 216 may have six circuit lines embedded therein. The second power source 214 may be electrically connected to two of the circuit lines through the two second electrical contacts EC2, and the other four circuit lines may be used by the second sensing element SE2. Similarly, the other six circuit lines of the external-connection circuit assembly 132 in FIG. 6 are electrically connected to the six circuit lines of the second circuit assembly 216. Therefore, the first circuit assembly 116 and the second circuit assembly 216 may be electrically connected to the aforementioned external circuit through the circuit lines of the external-connection circuit assembly 132.

In addition, as shown in FIG. 11, the first base 112 further has a first plane SS1, a second plane SS2, and a step structure 112S, and the step structure 112S is formed between the first plane SS1 and the second plane SS2.

When viewed along the first axis AX1, the first plane SS1 overlaps the second connecting element 110. When viewed along the first axis AX1, the second plane SS2 does not overlap the second connecting element 110, and when viewed along the second axis AX2, the step structure 112S overlaps the installation portion 112D.

Based on such a structural configuration, the convenience of installing the second connecting element 110 can be increased, and the optical element driving mechanism 10 can also achieve the purpose of overall miniaturization.

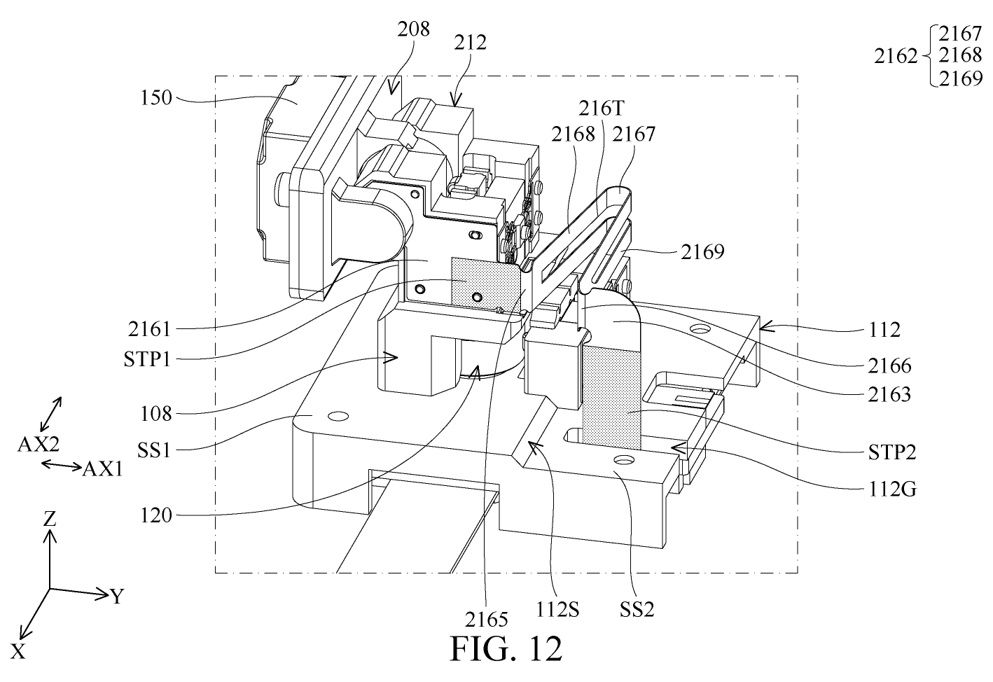

Please refer to FIG. 12. FIG. 12 is a three-dimensional schematic diagram of the optical element driving mechanism 10 according to another embodiment of the present application. Similar to the aforementioned embodiment, in this embodiment, the second optical module 200 also includes a first reinforcing element STP1 and a second reinforcing element STP2 which are fixedly connected to the fifth segment 2161 and the seventh segment 2163 respectively.

The aforementioned third reinforcing element STP3 is omitted on the third bent segment 2167. Specifically, a movable trench 216T is formed on the sixth segment 2162, extending from the first straight section 2168 to the third bent segment 2167, and finally extending to the second straight section 2169.

Based on the design of the movable trench 216T, the flexibility of the sixth segment 2162 can be increased, and since the third reinforcing element STP3 is omitted, the second optical module 200 can further achieve the purpose of lightweight.

In conclusion, the present disclosure provides an optical element driving mechanism 10, including a first optical module 100, a second optical module 200, a first driving assembly DA1, and a second driving assembly DA2. The second movable part 208 of the second optical module 200 is configured to carry an imaging module 150, and the second optical module 200 is fixedly disposed on the first movable part 108 of the first optical module 100. The first driving assembly DA1 is configured to drive the first movable part 108 and the second optical module 200 to rotate around the first rotation axis RX1, and the second driving assembly DA2 is configured to drive the second movable part 208 and the imaging module 150 to rotate around the second rotation axis RX2 relative to the first movable part 108 and the first base 112.

Furthermore, the optical element driving mechanism 10 may further include a first circuit assembly 116, a second circuit assembly 216, an integrated circuit assembly 130, and an external-connection circuit assembly 132, and the first circuit assembly 116 and the second circuit assembly 216 may be electrically connected to an external circuit through the integrated circuit assembly 130 and the external-connection circuit assembly 132. The second circuit assembly 216 has a fifth segment 2161, a sixth segment 2162, a seventh segment 2163, and an eighth segment 2164. The fifth segment 2161 is fixedly connected to the second base 212. The sixth segment 2162 is connected between the fifth segment 2161 and the seventh segment 2163, and the eighth segment 2164 is bent from the seventh segment 2163 and connected to the integrated circuit assembly 130.

In addition, the fifth segment 2161 may be formed with a plurality of engaging holes, and the second base 212 may be correspondingly formed with a plurality of engaging protruding portions to engage with the engaging holes respectively. Based on such a configuration, the fifth segment 2161 can be easily and accurately positioned on the second base 212, and the problem that the fifth segment 2161 may rotate around the second axis AX2 can also be avoided. Furthermore, the fifth segment 2161 can also be further fixed to the second base 212 using glue to ensure that when the second base 212 rotates, the fifth segment 2161 does not be separated from the second base 212.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A optical element driving mechanism, comprising:
a first optical module and a second optical module, wherein the first optical module includes:
a fixed assembly;
a first movable part, configured to be connected to the second optical module, wherein the first movable part is movable relative to the fixed assembly; and
a first driving assembly, configured to drive the first movable part to move relative to the fixed assembly.

2. The optical element driving mechanism as claimed in claim 1, wherein
the fixed assembly has a first base;
the first movable part is configured to be movably connected to the first base along a main axis;
the first optical module further includes a first positioning base which is connected to the first base;
the first optical module further includes a first connecting assembly configured to connect the first driving assembly and the first positioning base to the first base;
the first connecting assembly includes a first connecting element and a second connecting element;
the first connecting element is configured to connect the first positioning base and the first driving assembly;
the first base has an installation portion; and
the second connecting element is configured to connect the first positioning base and the installation portion.

3. The optical element driving mechanism as claimed in claim 2, wherein
the first base has a first accommodation space which is configured to accommodate at least a portion of the first driving assembly and the first positioning base;
the first driving assembly has a first transmission assembly, a first contact element and a first power source;
the first power source is configured to generate a first driving force which is configured to push the first transmission assembly;
the first transmission assembly is configured to transmit the first driving force;
the first contact element is disposed on the first transmission assembly and is configured to transmit the first driving force;
the first accommodation space has a first avoiding space corresponding to the first transmission assembly; and
the first base has a first accommodating surface which is disposed in the first accommodation space and is configured to support a portion of the first positioning base.

4. The optical element driving mechanism as claimed in claim 3, wherein
the first base defines a first axis and a second axis;
the first axis is perpendicular to the second axis;
the first base further includes a first plane, a second plane and a step structure;
the step structure is formed between the first plane and the second plane;
when viewed along the first axis, the first plane overlaps the second connecting element;
when viewed along the first axis, the second plane does not overlap the second connecting element; and
when viewed along the second axis, the step structure overlaps the installation portion.

5. The optical element driving mechanism as claimed in claim 4, wherein
the second optical module includes a second driving assembly, a second positioning base and a second base;
the second positioning base is fixedly disposed on the second base;
the second optical module further includes a second connecting assembly which is configured to connect the second driving assembly and the second positioning base to the second base;
the second connecting assembly includes a third connecting element and a fourth connecting element;
the third connecting element is configured to connect the second positioning base and the second driving assembly;
the fourth connecting element is configured to connect the second positioning base and the second base; and
the second base further has a second accommodation space which is configured to accommodate at least a portion of the second positioning base.

6. The optical element driving mechanism as claimed in claim 5, wherein
the first optical module further includes a first rotary assembly which is disposed on the first base;
the first rotary assembly has a first stator and a first rotor;
the first stator is located between a positioning protruding portion of the first base and the first rotor;
the first movable part is fixedly connected to the first rotor; and
the first contact element drives the first rotor to rotate relative to the first stator around a first rotation axis according to the first driving force.

7. The optical element driving mechanism as claimed in claim 6, wherein
the second driving assembly has a second transmission assembly, a second contact element and a second power source;
the second power source is configured to generate a second driving force and configured to push the second transmission assembly;
the second transmission assembly is configured to transmit the second driving force;
the second contact element is disposed on the second transmission assembly and is configured to transmit the second driving force;
the second optical module further includes a second movable part; and
the second base is fixedly disposed on the first movable part, and the second movable part is movable relative to the second base.

8. The optical element driving mechanism as claimed in claim 7, wherein
the second optical module further has a second rotary assembly and a fixed shaft;
the second movable part is movably connected to the second base through the second rotary assembly and the fixed shaft;
the fixed shaft passes through the second base and the second rotary assembly;
the second driving force is transmitted to the second rotary assembly through the second contact element to drive the second movable part to rotate around a second rotation axis; and
the second rotation axis is perpendicular to the first rotation axis.

9. The optical element driving mechanism as claimed in claim 8, wherein
the second connecting element has a first connecting end, a second connecting end, a first flexible portion, and a third connecting end;
the first connecting end and the third connecting end are fixedly connected to the first base;
the second connecting end is fixedly connected to the first positioning base;
the first base has a first fixed protruding portion, a second fixed protruding portion, a third fixed protruding portion and a fourth fixed protruding portion;
the first connecting end has a first installation hole and a second installation hole which are respectively mounted on the first fixed protruding portion and the second fixed protruding portion; and
the third connecting end has a third installation hole and a fourth installation hole which are respectively mounted on the third fixed protruding portion and the fourth fixed protruding portion.

10. The optical element driving mechanism as claimed in claim 9, wherein
the fourth connecting element has an elastic material;
the fourth connecting element has a fourth connecting end, a fifth connecting end, a second flexible portion and a sixth connecting end;
the fourth connecting end and the sixth connecting end are fixedly connected to the second base;
the fifth connecting end is fixedly connected to the second positioning base;
the second flexible portion is connected between the fourth connecting end and the fifth connecting end;
the second base has a fifth fixed protruding portion, a sixth fixed protruding portion, a seventh fixed protruding portion and an eighth fixed protruding portion; and
the fourth connecting end has a fifth installation hole and a sixth installation hole which are respectively mounted on the fifth fixed protruding portion and the sixth fixed protruding portion.

11. The optical element driving mechanism as claimed in claim 10, wherein
when viewed along the first axis, a size of the fifth installation hole is equal to a size of the fifth fixed protruding portion;
when viewed along the first axis, a size of the sixth installation hole is larger than a size of the sixth fixed protruding portion;
when viewed along the first axis, the sixth installation hole extends along the second axis;
the sixth connecting end has a seventh installation hole and an eighth installation hole which are respectively mounted on the seventh fixed protruding portion and the eighth fixed protruding portion;
when viewed along the first axis, a size of the seventh installation hole is equal to a size of the seventh fixed protruding portion; and
when viewed along the first axis, a size of the eighth installation hole is larger than a size of the eighth fixed protruding portion.

12. The optical element driving mechanism as claimed in claim 11, wherein
the first optical module further includes a first circuit assembly, an integrated circuit assembly and an external-connection circuit assembly;
the first circuit assembly and the integrated circuit assembly are fixedly disposed on the first base;
the first circuit assembly is electrically connected to an external circuit through the integrated circuit assembly and the external-connection circuit assembly;
the first circuit assembly has a first segment, a second segment, a third segment and a fourth segment;
the first base has a top surface and a side wall;
the first segment and the second segment are affixed to the top surface and the side wall respectively;
the third segment is connected between the second segment and the fourth segment; and
the fourth segment is electrically connected to the integrated circuit assembly.

13. The optical element driving mechanism as claimed in claim 12, wherein
the second optical module further includes a second circuit assembly which is configured to be electrically connected to the second driving assembly and the integrated circuit assembly;
the second circuit assembly has a fifth segment, a sixth segment, a seventh segment, and an eighth segment;
the fifth segment is fixedly connected to the second base;
the sixth segment is connected between the fifth segment and the seventh segment;
the seventh segment extends along the main axis;
the eighth segment is bent from the seventh segment and connected to the integrated circuit assembly;
when viewed along the main axis, the sixth segment has a v-shaped structure;
the second circuit assembly further has a fixed segment which is bent from the fifth segment; and
the fixed segment is fixedly disposed on the first movable part.

14. The optical element driving mechanism as claimed in claim 13, wherein
the second base has a first engaging protruding portion, a second engaging protruding portion, a third engaging protruding portion, a fourth engaging protruding portion, and a fifth engaging protruding portion;
the fifth segment has a first engaging hole, a second engaging hole, a third engaging hole, and a fourth engaging hole; and
the first engaging protruding portion, the second engaging protruding portion, the third engaging protruding portion, and the fourth engaging protruding portion are configured to respectively engage with the first engaging hole, the second engaging hole, the third engaging hole, and the fourth engaging hole.

15. The optical element driving mechanism as claimed in claim 14, wherein
when viewed along the second axis, a size of the first engaging hole is equal to a size of the first engaging protruding portion;
when viewed along the second axis, a size of the second engaging hole is larger than a size of the second engaging protruding portion;
when viewed along the second axis, a size of the third engaging hole is larger than a size of the third engaging protruding portion;
when viewed along the second axis, a size of the fourth engaging hole is larger than a size of the fourth engaging protruding portion; and
when viewed along the second axis, the fourth engaging hole has a long strip-shaped structure which extends along the first axis.

16. The optical element driving mechanism as claimed in claim 15, wherein
the second base has a through hole, and the fixed shaft is configured to pass through the through hole;
when viewed along the main axis, a length of the through hole is greater than a length of the fixed shaft;
the second optical module further includes a second sensing element and a second magnetic element;
the through hole and the fixed shaft form an accommodation space which is configured to accommodate the second sensing element; and
the second sensing element is disposed on the fifth segment.

17. The optical element driving mechanism as claimed in claim 16, wherein
the second movable part has a side accommodating portion which is disposed on one side of the second base, corresponding to the accommodation space;
the side accommodating portion has an accommodating groove which is configured to accommodate the second magnetic element;
when viewed along the main axis, the second magnetic element and the second sensing element are located on opposite sides of the fifth segment; and
when viewed along the second axis, the side accommodating portion overlaps the second sensing element, the fixed shaft and the through hole.

18. The optical element driving mechanism as claimed in claim 17, wherein
the second circuit assembly further includes a first bent segment, a second bent segment and a third bent segment;
the first bent segment is connected between the fifth segment and the sixth segment;
the second bent segment is connected between the sixth segment and the seventh segment;
the sixth segment has a first straight section and a second straight section; and
the third bent segment is connected between the first straight section and the second straight section.

19. The optical element driving mechanism as claimed in claim 18, wherein
the second optical module further includes a first reinforcing element, a second reinforcing element and a third reinforcing element;
the first reinforcing element is fixedly connected to a portion of the fifth segment;
the second reinforcing element is fixedly connected to a portion of the seventh segment; and
the third reinforcing element is fixedly connected to the third bent segment.

20. The optical element driving mechanism as claimed in claim 19, wherein
the fixed segment is formed with a fifth engaging hole, and the fifth engaging protruding portion is configured to pass through the fifth engaging hole;
when viewed along the main axis, a size of the fifth engaging hole is greater than a size of the fifth engaging protruding portion;
when viewed along the main axis, the fifth engaging hole has a long strip-shaped structure which extends along the second axis;
the fixed segment is further formed with two second electrical contacts, which are configured to be electrically connected to the second power source;
the second power source has two leading wires;
the second positioning base has two notches; and
the two leading wires are configured to respectively pass through the two notches and then to be electrically connected to the two second electrical contacts.
